(19) United States
(12) Patent Application Publication
(10) Pub. No.: US 2016/0017943 A1
(43) Pub. Date: Jan. 21, 2016

(54) DRUM BRAKE SHOE

(71) Applicant: TMD Friction Services GmbH, Leverkusen (DE)

(72) Inventor: Willmut RÖHLING, Ruppichteroth (DE)

(73) Assignee: TMD Friction Services GmbH, Leverkusen (DE)

(21) Appl. No.: 14/541,752

(22) PCT Filed: May 28, 2013
(86) PCT No.: PCT/EP2013/060922

§ 371 Date: Nov. 14, 2014

(30) Foreign Application Priority Data
May 30, 2012 (DE) 10 2012 104 666.2

(51) Int. Cl. F16D 65/00; F16D 69/04; F16D 65/08

(52) U.S. Cl. CPC F16D 65/0006; F16D 65/08; F16D 69/04; F16D 2069/0441

(57) ABSTRACT

The invention relates to a drum brake shoe (1), comprising a lining carrier (2) and a friction lining (3) fastened to the lining carrier (2). The drum brake shoe is characterized in that at least one damping component (7) is arranged between the lining carrier (2) and the friction lining (3).

### CROSS-REFERENCE TO RELATED APPLICATIONS

This application is a national stage application (under 35 USC §371) of PCT/EP2013/060922, filed May 28, 2013, which claims benefit of German application 10 2012 104 666.2, filed May 30, 2012.

### BACKGROUND OF THE INVENTION

### Technical Field and State of the Art

The invention relates to a drum brake shoe having a lining carrier and a friction lining attached to the lining carrier, whereby at least one damping component is arranged between the lining carrier (2) and the friction lining.

The invention also relates to a lining kit for the production of a drum brake shoe according to the invention, especially as a retrofit, and it also relates to a method for the production of a drum brake shoe.

Many drum brakes develop loud braking noises during braking, especially after they have been broken in. These noises are usually perceived as annoying squeaking sounds.

A number of technical solutions have already been proposed with an eye towards preventing the generation of noise.

For instance, German patent application DE 546 795 A discloses a damping device for reducing squeaking noises in vehicle brakes in which a damping means in the form of a compound is provided which is arranged so that it can be moved to a limited extent against the brake shoe in an elastically yielding manner under friction, or which is arranged so as to be pressed against parts that are connected to said brake shoe.

German patent specification DE 29 14 629 C2 discloses a vibration-damped brake shoe for the drum brake of a bus, comprising an arched lining carrier to which a reaction compound is attached while, at the same time, a friction interlayer is inserted, said reaction compound being applied on the circumferential surface of the lining carrier that faces radially inwards. In this brake shoe, a viscoelastic layer exhibiting high internal damping characteristics is arranged between the friction layer and the reaction compound.

German patent application DE 31 40 918 A1 discloses a brake shoe for drum brakes. The brake shoe has a brake lining that adapts to the friction surface of the brake drum, whereby the cross section of the brake lining that is parallel to the rotational axis of the brake drum has a spring constant that changes in the cross-sectional direction.

German patent document DE 2 259 770 discloses brake shoes with a pressed-on brake lining as well as a method for its production. The method for the production of such a brake shoe having a brake lining that has been pressed on directly consists of applying, for example, gluing a damping layer—preferably already vulcanized—onto the brake shoe, after which a brake lining mixture, for example, in granulate form, is pressed onto the brake shoe, as a result of which the brake lining is shaped and affixed to the brake shoe as well as to the damping layer.

The German translation of EP patent DE 690 29 408 T2 discloses a noise-reducing brake shoe for an automobile drum brake comprising a metallic brake pad. On the inner diameter of the brake block, there are grooves that run sideways and into which noise-damping segments made of elastomer are inserted, whereby the thickness of the noise-damping segments is the same as the depth of the grooves. European patent application EP 0 849 488 A1 discloses a brake shoe comprising a lining carrier and a friction lining as well as an interlayer arranged between the friction lining and the lining carrier as a damping element that serves to prevent friction squeaking. The interlayer is made of a material mixture which, on the one hand, damps friction squeaking during operation of the brake and, on the other hand, generates an alarm sound once the wear limit has been reached.

The solutions known from the state of the art have proven in actual practice to either be insufficiently effective or else to be too complicated, for example, especially in terms of vibration compounds that have to be additionally installed. Moreover, it is often not possible, or else only with considerable effort, for existent drum brakes which had not been originally configured as noise-reducing brakes to be retrofitted in order to attain a noise reduction.

### BRIEF SUMMARY OF THE INVENTION

Before this backdrop, it is an objective of the present invention to put forward a drum brake shoe with which the generation of noise during braking is largely prevented, or at least considerably reduced, and which can also be configured, especially in a structurally simple manner, in such a way as to allow retrofitting of existing systems.

This objective is achieved by a drum brake shoe that is characterized in that the damping component is arranged at least partially in a recess of the friction lining and/or in a recess of the lining carrier, and it is clamped between the lining carrier and the friction lining

Another objective of the present invention is to put forward a lining kit that, by means of a retrofitting method, makes it possible to produce a drum brake shoe according to the invention.

This objective is achieved by means of a lining kit comprising a friction lining and at least one damping component that can be clamped between the friction lining and a friction carrier, whereby the friction lining and/or the lining carrier (2) has a recess in which the damping component can be positioned, at least partially, especially with a positive fit.

Moreover, another objective of the present invention is to put forward a method for the production of a drum brake shoe which has been optimized with an eye towards reducing the generation of noises.

This objective is achieved by means of a method characterized by the following steps:

a) attaching a damping component to a lining carrier,

b) attaching a friction lining to the lining carrier in such a way that the damping component is clamped, at least partially, between the friction lining and the lining carrier, and is arranged, at least partially, in a recess of the friction lining and/or in a recess of the lining carrier.

It has been recognized according to the invention that a gap is left between the lining carrier and the normally riveted friction lining and that direct close contact exists only in the immediate vicinity of the fastening rivets, so that the friction lining can vibrate, at least in the areas where it is not in direct contact with the brake shoe, thereby promoting the generation of braking noises. According to an essential inventive idea, the damping component considerably reduces the tendency towards vibration and, in the ideal case, it even completely suppresses it.

It has been found that the generation of brake noises can be reduced very drastically especially in that the damping component is clamped between the lining carrier and the friction lining and/or in that the friction lining is attached to the lining carrier, thereby compressing the damping component, that is to say, against the internal forces that strive to return the damping component to its original shape. For this purpose, it can be provided, for example, that the damping component is at first arranged between the lining carrier and the friction lining, somewhat in the manner of a spacer, and that subsequently the friction lining—especially on both sides of the damping component as well as at attachment points situated at a distance from it—is attached, especially riveted, to the lining carrier. As an alternative or in addition, it can also be provided that the curvature of the friction lining has a smaller radius of curvature than that of the lining carrier, so that the friction lining that is to be attached under tension to the lining carrier exerts an additional clamping force onto the damping component

Fundamentally speaking, it is not ruled out that the damping component covers the entire side of the lining carrier facing the friction lining and/or the entire side of the friction lining facing the lining carrier. In a particularly effective embodiment which nevertheless requires considerably less material, it is provided that the damping component covers only a portion of the side of the lining carrier facing the friction lining and/or that the damping component covers only a portion of the side of the friction lining facing the lining carrier.

In a particularly advantageous embodiment, the damping component is configured so as to be rod-shaped.

In an especially advantageous embodiment, the damping component is positioned in the middle between two attachment points, especially between two riveted connections between the lining carrier and the friction lining.

In order for the noise-damping effect to come to the fore, it is usually already sufficient for the damping component to rest against a small portion of the side of the lining carrier facing the friction lining and against a small portion of the side of the friction lining facing the lining carrier. This portion can be less than 20%, especially less than 10%, of the side in question.

According to the invention, the damping component is arranged at least partially in a recess of the friction lining and/or in a recess of the lining carrier. In particular, it can be provided that the damping component is arranged with a positive fit and at least partially in a recess of the friction lining and/or in a recess of the lining carrier. Such an embodiment has the special advantage that, for one thing, the recesses already show the mechanic the position and/or the location in which the damping component has to be inserted. This advantageously avoids the risk of incorrect installation. Moreover, such an embodiment entails the additional advantage that the damping component can absorb shear forces that occur between the lining carrier and the friction lining, particularly during braking. This is especially the case if the lengthwise extension of the damping component—configured, for instance, so as to be rod-shaped—is arranged perpendicular to the direction of the shear forces that occur between the lining carrier and the friction lining during braking.

The above-mentioned embodiment also has the advantage that it can dispense with some of the joining elements, especially rivets, employed to attach the friction lining to the lining carrier.

For this reason, especially with an eye towards retrofitting existing systems with the technology according to the invention, it can be advantageously provided according to the invention that some of the holes that were originally intended for riveting the friction lining to the lining carrier are no longer employed to rivet the friction lining but rather to attach the damping element to the lining carrier, for instance, by means of a screwed connection. In another step, the friction lining can subsequently be riveted on, making use of the remaining holes in the lining carrier, optionally while clamping the damping element. Preferably, holes located at the edge of the lining carrier are employed to rivet the friction lining, whereas the holes located in-between are used to attach the damping element.

In a special embodiment, the damping component is made at least partially of cork.

This embodiment entails the special advantages that cork, for example, in compressed granulate form, is available at low prices and that cork is also very temperature-resistant and does not flow. Cork also recovers its original shape, even after prolonged exposure to compressive stress. Alternatively or additionally, it can also be provided for the damping component to have at least one elastomer.

It can especially be provided for the damping component to consist of several components that are joined together, especially glued together. In one special embodiment, the damping element comprises a dimensionally stable carrier, for instance, a metal rail or a metal plate, and an elastic damping element. The damping element can especially be configured, for instance, as a cork layer or an elastomeric layer that is attached, especially glued, to the carrier.

The provision of an essentially dimensionally stable carrier has the particular advantage that additional joining elements such as, for instance, threaded holes, can be provided on and/or in the carrier in a simple and reliable manner, so that the damping component can be attached to the lining carrier, for example, by means of screwed connections.

In particular, it can be provided that the damping component is attached to the lining carrier by means of at least one joining element, particularly a screw. For instance, the joining element can pass radially through the lining carrier.

In particular, the damping component can be in the form of a metal plate that is provided with an approximately 3 mm-thick damping element, whereby the damping component is compressed by about 1 mm when the friction lining is riveted on.

As already mentioned, a drum brake shoe according to the invention can also be produced by retrofitting or refurbishing an existing brake shoe, especially when the original friction lining is worn out anyway and needs to be replaced. For this purpose, in the manner according to the invention, a lining kit can be employed which, as already elaborated upon, has a friction lining and at least one damping component that is to be arranged, especially clamped, between the friction lining and the lining carrier.

The parts of the lining kit such as, for instance, the friction lining and the damping component, can have the additional features described above in conjunction with the drum brake shoe according to the invention, such as, for example, a recess for the damping component and/or special configurations of the damping component.

Particularly with an eye towards reducing the noises generated, it is especially advantageous to have a drum brake that has at least one drum brake shoe according to the invention and/or that is equipped with at least one lining kit according to the invention and/or that is produced by means of the methods according to the invention.

Additional objectives, advantages, features and application possibilities of the present invention ensue from the description below of an embodiment with reference to the drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

The following is shown:

FIG. 1 a cross-sectional view of an embodiment of a drum brake according to the invention, and

FIG. 2 a detailed view of an embodiment of a drum brake shoe according to the invention, in a top view.

### DETAILED DESCRIPTION OF THE INVENTION

### Detailed Description of Embodiments

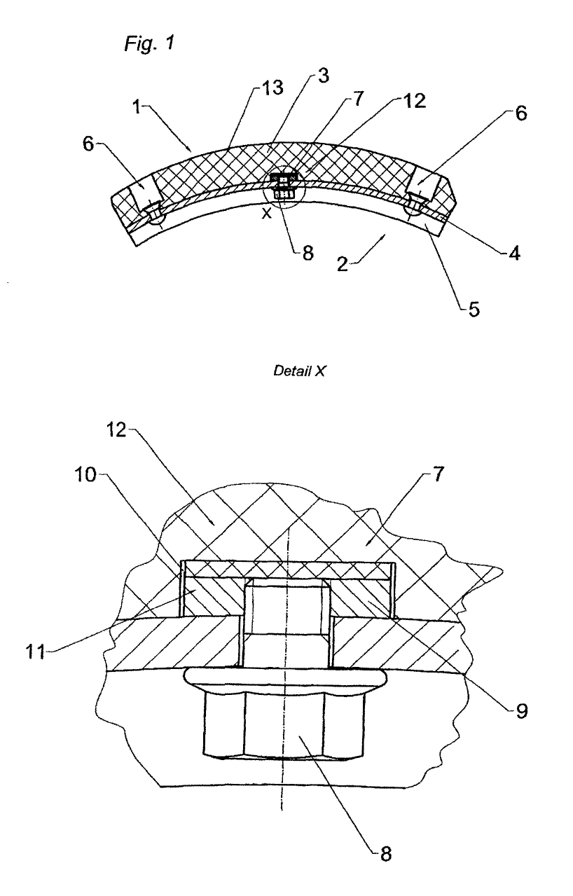

FIG. 1 shows an embodiment of a drum shoe brake 1 according to the invention, comprising a lining carrier 2 and a friction lining 3 attached to the lining carrier. The lining carrier 2 is configured in the form of a curved T-carrier having a flange 4 and a web 5. The friction lining 3 is attached to the lining carrier 2 by means of rivet connections 6. Between the lining carrier 2 and the friction lining 3, there is a damping component 7 that is attached to the lining carrier by means of screws 8 that pass through a hole in the lining carrier 2.

FIG. 1 contains a detailed view showing that the damping component 7 consists of a preferably metallic carrier and of a glued-on damping element 10, namely, a cork layer. Threaded holes 11 have been drilled into the carrier 9 for the screws 8.

The damping component 7 is situated in a recess 12, namely, in an elongated groove in the friction lining 3. However, the depth of the recess 12 is preferably of a smaller magnitude than the height of the damping component 7 so that the damping component is compressed and clamped when the friction lining 3 is riveted onto the lining carrier 2.

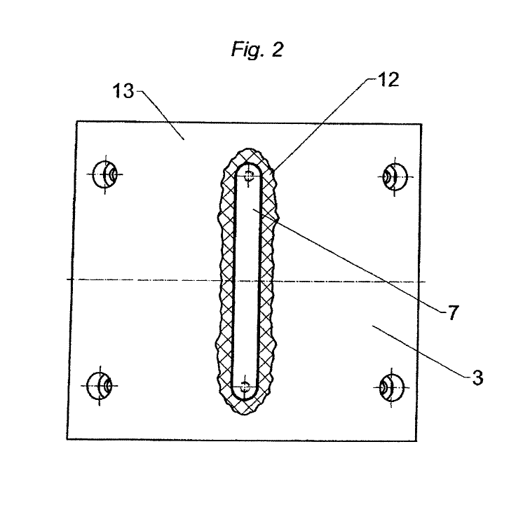

FIG. 2 shows a top view and partially a through-view through the side 13 of the friction lining 3. It can be seen that the damping component is configured so as to be elongated and it is arranged in an elongated recess of the friction lining 3.

The lengthwise extension of the damping component is arranged perpendicular to the direction of the tangential shear forces that occur between the lining carrier 2 and the friction lining 3 during braking. Since, on the one hand, the damping component is firmly joined to the lining carrier 2 by means of the screws 8 and, on the other hand, inserted with a positive fit into the elongated recess 12 of the friction lining 3, any tangential shear forces that might occur can be absorbed by the damping component. For instance, it can be provided that the holes in the lining carrier 2 intended for the screws 8 are actually those that had been originally intended for riveting the conventional friction linings without a damping component.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### List of Reference Numerals

1 drum brake shoe
2 lining carrier
3 friction lining
4 flange
5 web
6 riveted connection
7 damping component
8 screw
9 carrier
10 damping element
11 threaded hole
12 recess
13 friction side

1. A drum brake shoe (1) comprising:
a lining carrier (2);
a friction lining (3) attached to the lining carrier (2), said friction lining (3) defining a recess (12); and
at least one damping component (7) arranged between the lining carrier (2) and the friction lining (3) and fitted with a positive fit at least partially in the recess (12) of the friction lining (3), and clamped between the lining carrier (2) and the friction lining (3).

2. The drum brake shoe (1) according to claim 1, wherein the friction lining (3) is attached to the lining carrier (2), thereby compressing the damping component (7).

3. The drum brake shoe (1) according to claim 1, wherein the damping component (7) covers only a portion of the side of the lining carrier (2) facing the friction lining (3) and/or the damping component (7) covers only a portion of the side of the friction lining (3) facing the lining carrier (2).

4. (canceled)

5. The drum brake shoe (1) according to claim 1, wherein:
a) the recess (12) and/or the damping component (7) is/are configured so as to be elongated, and/or
b) the recess (12) and/or the damping component (7) is/are configured and arranged so as to absorb shear forces that occur between the lining carrier (2) and the friction lining (3) during braking, and/or
c) the recess (12) and/or the damping component (7) is/are arranged perpendicular to the direction of the shear forces that occur between the lining carrier (2) and the friction lining (3) during braking.

6. The drum brake shoe (1) according to claim 1, wherein the damping component (7) is made at least partially of cork and/or of an elastomer.

7. The drum brake shoe (1) according to claim 1, wherein
a) the damping component (7) comprises a dimensionally stable carrier (9) and of an elastic damping element (10), and/or
b) the damping component (7) comprises a metallic carrier, and a damping element (10), and/or
c) the damping component (7) comprises a metallic carrier (9), and a damping element (10) firmly joined to the carrier (9).

8. The drum brake shoe (1) according to claim 1, wherein
a) the damping component (7) is attached to the lining carrier (2) by at least one joining element, such as a screw (8), and/or
b) the damping component (7) is attached to the lining carrier (2) by at least one joining element that passes radially through the lining carrier, and/or
c) the carrier of the damping component (7) has a joining element, such as an inner thread, for attaching the damping component (7) to the lining carrier (2).

9. A lining kit for the production of a drum brake shoe (1) with a friction lining carrier (2), especially as a retrofit, according to claim 1, comprising:
a friction lining (3); and
at least one damping component (7) that can be clamped between the friction lining (3) and the friction carrier (2),
wherein the friction lining (3) and/or the lining carrier (2) defines a recess adapted to receive all of or at least partially the damping component (7) with a positive fit.

10. A lining kit according to claim 9 wherein
a) the damping component (7) comprises a metallic carrier (9), and a damping element (10), and/or
b) the damping component (7) comprises a metallic carrier (9), and a damping element (10) firmly joined to the carrier (9), and/or
c) the damping component (7) is attachable to the lining carrier (2) with a joining element, such as a screw (8), and/or
d) the damping component (7) is attachable to the lining carrier (2) with at least one joining element that passes radially through the lining carrier, and/or
e) the carrier (9) of the damping component (7) has a joining element, for attaching the damping component (7) to the lining carrier (2).

11. A method for the production of a drum brake shoe (1), comprising:
a) attaching a damping component (7) to a lining carrier (2), and
b) attaching a friction lining (3) to the lining carrier (2) in such a way that the damping component (7) is clamped, at least partially, between the friction lining (3) and the lining carrier (2), and is arranged, at least partially, in a recess of the friction lining (3) and/or in a recess of the lining carrier (2).

12. The method according to claim 11, wherein the damping component (7) is attached to the lining carrier (2) with a joining element, such as a rivet, that runs through a hole in the lining carrier (2) that is actually intended for attaching a friction lining.

13. The method according to claim 11, wherein
a) the damping component (7) is arranged fully or at least partially in a recess (12) of the friction lining (3), and/or in a recess (12) of the friction lining (3), so as to absorb the shear forces that occur between the lining carrier (2) and the friction lining (3) during braking, and/or
b) the recess and/or the damping component (7) is/are arranged perpendicular to the direction of the shear forces that occur between the lining carrier (2) and the friction lining (3) during braking.

14. A drum brake having at least one drum brake shoe (1) according to claim 1.

15. A drum brake shoe (1) that is equipped with a lining kit according to claim 9.

16. A drum brake shoe (1) that is produced by the method according to claim 11.
